(19) United States
(12) Patent Application Publication
(10) Pub. No.: US 2021/0027286 A1
(43) Pub. Date: Jan. 28, 2021

(54) CHAT-BASED PEER-TO-PEER TRANSACTION PLATFORM

(71) Applicant: Yury Strashnoy, Los Angeles, CA (US)

(72) Inventor: Yury Strashnoy, Los Angeles, CA (US)

(21) Appl. No.: 16/938,309

(22) Filed: Jul. 24, 2020

Related U.S. Application Data
(60) Provisional application No. 62/878,068, filed on Jul. 24, 2019.

(51) Int. Cl. G06Q 20/38; G06Q 20/22; G06Q 20/02; G06Q 40/02; G06Q 10/10; G06Q 50/18; H04L 12/58

(52) U.S. Cl. CPC G06Q 20/386; G06Q 20/223; G06Q 20/02; G06Q 50/34; G06Q 10/10; G06Q 50/182; H04L 51/046; G06Q 40/02

(57) ABSTRACT

Described is a system and method for peer-to-peer transactions using instant messaging programs. The system includes a first computing device configured with a first instant messenger program and in communication with a first instant messenger server. A second computing device is configured with a second instant messenger program and in communication with a second instant messenger server. The system further includes a chat service gateway configured to communicate with both the first and second instant messenger servers, and a marketplace server configured to communicate with the chat service gateway. The combination of the first and second computing devices, the first and second instant messenger servers, the chat service gateway, and the marketplace server performs a transaction between the first and second computing devices via the first and second instant messenger programs.

### CROSS-REFERENCE TO RELATED APPLICATIONS

This is a Non-Provisional application of U.S. Provisional Patent Application No. 62/878,068, filed Jul. 24, 2019, entitled, “Chat-Based Peer-to-Peer Transactional Platform”, the entirety of which is incorporated herein by reference.

### BACKGROUND OF INVENTION

### (1) Field of Invention

The present invention relates to a platform to facilitate peer-to-peer transactions and, more particularly, to a platform to facilitate peer-to-peer transactions using a variety of instant messaging platforms.

### (2) Description of Related Art

E-commerce is a fast-growing technological area that is constantly innovating and changing, but there remains a need for improvements that facilitate transactions in a more natural, person to person way. One major impediment to true peer-to-peer interaction is a requirement that users only conduct business using an application's service. Typical applications are primarily built to facilitate business transactions between users and applications (e.g., buying and selling goods/services, placing bets). Examples of existing applications that facilitate transactions include Amazon.com, Inc., eBay, Inc., Alibaba.com, Walmart Inc., Unikrn, Inc., UMG Events, LLC., Checkmate Gaming, LLC., Play One Up, LTD., and Player's Lounge, Inc. These applications are not built to facilitate peer-to-peer transactions using conversational communication, including instant messaging or other messaging methods. In the absence of a conversational system to guide users through a peer-to-peer transaction process, there is little use in directly messaging each other, which opens people up to scams and gives away a user's personal phone number.

Thus, a continuing need exists for a conversational system that facilitates peer-to-peer transactions, where users can use a wide variety of different instant messaging platforms based on their own personal preferences.

### SUMMARY OF INVENTION

The present invention relates to a platform to facilitate peer-to-peer transactions and, more particularly, to a platform to facilitate peer-to-peer transactions using a variety of instant messaging platforms. The system comprises a first computing device configured with a first instant messenger program and in electronic communication with a first instant messenger server; a second computing device configured with a second instant messenger program and in electronic communication with a second instant messenger server; a chat service gateway comprising one or more servers configured to communicate with both the first instant messenger server and the second instant messenger server; and a marketplace server configured to communicate with the chat service gateway, wherein the combination of the first and second computing devices, the first and second instant messenger servers, the chat service gateway, and the marketplace server are configured to perform a transaction between the first and second computing devices via the first and second instant messenger programs.

In another aspect, the system further comprises a tracker software in communication with the marketplace server, wherein the tracker software is configured to automatically track a result of the transaction between the first and second computing devices.

In another aspect, the system further comprises a referee in communication with the marketplace server, wherein the referee is configured to assist with settlement of the transaction.

The present invention further relates to a method for peer-to-peer transactions using instant messaging programs, the method comprising acts of initiating a transaction request between a first computing device configured with a first instant messenger program and a second computing device configured with a second instant messenger program, wherein initiating the transaction request comprises transmitting the transaction request from the first computing device to a first instant messenger server via the first instant messenger program; relaying, by the first instant messenger server, the transaction request to a chat service gateway, wherein the chat service gateway comprises one or more servers configured to communicate with a plurality of different instant messenger servers; sending, by the chat service gateway, the transaction request to a marketplace server, wherein the marketplace server creates a contract, credits an escrow account, and debits the first computing device; sending, by the marketplace server, the contract through the chat service gateway to a second instant messenger server; and relaying, by the second instant messenger server, the contract to the second computing device via the second instant messenger program.

In another aspect, the method further comprises acts of accepting the contract by the second computing device, wherein accepting the contract comprises transmitting an acceptance of the contract from the second computing device through the second instant messenger server via the second instant messenger program; relaying, by the second instant messenger server, the acceptance to the chat service gateway to the marketplace server, wherein the marketplace server activates the contract, credits the escrow account, and debits the second computing device; transmitting an acceptance notification to the first computing device from the marketplace server to the chat service gateway; relaying the acceptance notification from chat service gateway to the first instant messenger server; sending, by the first instant messenger server, the acceptance notification to the first computing device via the first instant messenger program.

In another aspect, the method further comprises acts of sending a tracking request to a tracker software once the marketplace server activates the contract; and generating, by the tracker software, a tracking confirmation, wherein the tracker software tracks a result of the contract between the first computing device and the second computing device.

In another aspect, the method further comprises acts of sending, by the first computing device, a settlement request to the marketplace server, wherein the marketplace server changes the contract to a settling state; transmitting, by the marketplace server, a settlement request to the chat service gateway, wherein the chat service gateway relays the settlement request to the second instant messenger server; sending, by the second instant messenger server, to the second computing device via the second instant messenger program; sending, by the second computing device, a settlement refusal to the second instant messenger server via the second instant messenger program when the second computing device refuses the settlement request; sending, by the second instant messenger server, the settlement refusal to the chat service gateway, wherein the chat service gateway transmits the settlement refusal to the marketplace server; changing, by the marketplace server, the contract from the settling state to a mediated state; and selecting a referee to assist with settlement of the contract, wherein the marketplace server sends a notification to the selected referee, and wherein the selected referee makes a settlement decision.

In another aspect, the referee changes the contract to a settled state, debits the escrow account, and credits one or more of the computing devices, and the method further comprises acts of sending, by the referee, a settlement confirmation to the marketplace server, wherein the marketplace server sends the settlement confirmation to the chat service gateway; and sending, by the chat service gateway, the settlement confirmation to the first instant messenger server which relays the settlement confirmation to the first computing device via the first instant messenger program.

The present invention further relates to a method for peer-to-peer transactions using instant messaging programs, the method comprising acts of transmitting a first transaction request from a first computing device to a first instant messenger server via a first instant messenger program; relaying, by the first instant messenger server, the first transaction request to a chat service gateway, wherein the chat service gateway comprises one or more servers configured to communicate with a plurality of different instant messenger servers; sending, by the chat service gateway, the first transaction request to a marketplace server, wherein the marketplace server creates a contract, credits an escrow account, and debits the first computing device; transmitting a second transaction request from a second computing device to a second instant messenger server via a second instant messenger program; relaying, by the second instant messenger server, the second transaction request to the chat service gateway; checking, by the marketplace server, that the second transaction request corresponds to the first transaction request; and activating, by the marketplace server, a contract between the first computing device and the second computing device, wherein the marketplace server creates a contract, credits an escrow account, and debits the second computing device.

The present invention further relates to a method for peer-to-peer transactions using instant messaging programs, the method comprising acts of initiating a transaction request between a first computing device configured with a first instant messenger program and a plurality of computing devices configured with a plurality of instant messenger programs, wherein initiating the transaction request comprises: transmitting the transaction request from the first computing device to a first instant messenger server via the first instant messenger program; relaying, by the first instant messenger server, the transaction request to a chat service gateway, wherein the chat service gateway comprises one or more servers configured to communicate with a plurality of different instant messenger servers; sending, by the chat service gateway, the transaction request to a marketplace server, wherein the marketplace server creates a contract, credits an escrow account, and debits the first computing device; sending, by the marketplace server, the contract through the chat service gateway to one or more instant messenger servers; and relaying, by the one or more instant messenger servers, the contract to the plurality of computing devices via the plurality of instant messenger programs.

Finally, the present invention also includes a computer program product and a computer implemented method. The computer program product includes computer-readable instructions stored on a non-transitory computer-readable medium that are executable by a computer having one or more processors, such that upon execution of the instructions, the one or more processors perform the operations listed herein. Alternatively, the computer implemented method includes an act of causing a computer to execute such instructions and perform the resulting operations.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1 is a block diagram depicting the components of a system for facilitating peer-to-peer transactions according to some embodiments of the present disclosure; and

FIG. 2 is an illustration of a computer program product according to some embodiments of the present disclosure.

FIG. 3 is a flow diagram illustrating a transaction flow without a tracker according to embodiments of the present disclosure;

FIG. 4 is a flow diagram illustrating a transaction flow with a tracker according to embodiments of the present disclosure;

FIG. 5 is a flow diagram illustrating a settlement flow that includes a referee according to embodiments of the present disclosure;

FIG. 6 is a flow diagram illustrating a settlement flow that includes a tracker according to embodiments of the present disclosure;

FIG. 7 is a flow diagram illustrating a transaction flow for a request from a first user and a matching request from a second user according to embodiments of the present disclosure;

FIG. 8 is a sequence diagram illustrating a transaction flow without a tracker according to embodiments of the present disclosure;

FIG. 9 is a sequence diagram illustrating a settlement flow that includes a referee according to embodiments of the present disclosure;

FIG. 10 is a sequence diagram illustrating a transaction flow with a tracker according to embodiments of the present disclosure;

FIG. 11 is a sequence diagram illustrating a settlement flow that includes a tracker according to embodiments of the present disclosure;

FIG. 12 is a sequence diagram illustrating a transaction flow for a request from a first user and a matching request from a second user according to embodiments of the present disclosure.

FIG. 13 is a flow diagram illustrating a transaction flow for an open offer/bet from one user to many users according to embodiments of the present disclosure;

FIG. 14 is a flow diagram illustrating a transaction flow for an open offer of goods/services from one user to many users according to embodiments of the present disclosure; and

FIG. 15 is a flow diagram illustrating a transaction flow for an open offer to join a tournament from one user to many users according to embodiments of the present disclosure.

### DETAILED DESCRIPTION

The present invention relates to a platform to facilitate peer-to-peer transactions and, more particularly, to a platform to facilitate peer-to-peer transactions using a variety of instant messaging platforms. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of aspects. Thus, the present invention is not intended to be limited to the aspects presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

(1) Principal Aspects

Various embodiments of the invention include three “principal” aspects. The first is a system for facilitating peer-to-peer transactions. The system is typically in the form of a computer system operating software or in the form of a “hard-coded” instruction set. This system may be incorporated into a wide variety of devices that provide different functionalities. The second principal aspect is a method, typically in the form of software, operated using a data processing system (computer). The third principal aspect is a computer program product. The computer program product generally represents computer-readable instructions stored on a non-transitory computer-readable medium such as an optical storage device, e.g., a compact disc (CD) or digital versatile disc (DVD), or a magnetic storage device such as a floppy disk or magnetic tape. Other, non-limiting examples of computer-readable media include hard disks, read-only memory (ROM), and flash-type memories. These aspects will be described in more detail below.

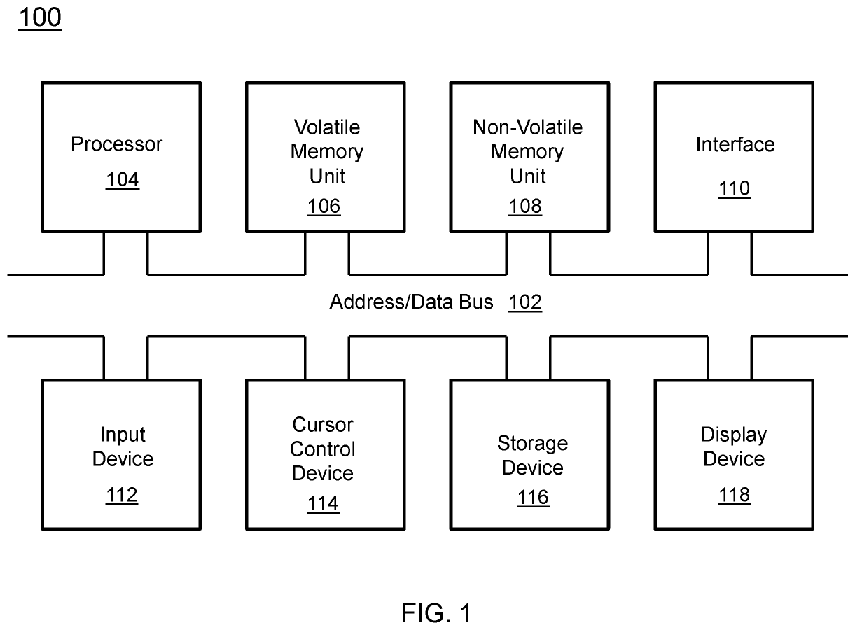

A block diagram depicting an example of a system (i.e., computer system 100) of the present invention is provided in FIG. 1. The computer system 100 is configured to perform calculations, processes, operations, and/or functions associated with a program or algorithm. In one aspect, certain processes and steps discussed herein are realized as a series of instructions (e.g., software program) that reside within computer readable memory units and are executed by one or more processors of the computer system 100. When executed, the instructions cause the computer system 100 to perform specific actions and exhibit specific behavior, such as described herein.

The computer system 100 may include an address/data bus 102 that is configured to communicate information. Additionally, one or more data processing units, such as a processor 104 (or processors), are coupled with the address/data bus 102. The processor 104 is configured to process information and instructions. In an aspect, the processor 104 is a microprocessor. Alternatively, the processor 104 may be a different type of processor such as a parallel processor, application-specific integrated circuit (ASIC), programmable logic array (PLA), complex programmable logic device (CPLD), or a field programmable gate array (FPGA).

The computer system 100 is configured to utilize one or more data storage units. The computer system 100 may include a volatile memory unit 106 (e.g., random access memory (“RAM”), static RAM, dynamic RAM, etc.) coupled with the address/data bus 102, wherein a volatile memory unit 106 is configured to store information and instructions for the processor 104. The computer system 100 further may include a non-volatile memory unit 108 (e.g., read-only memory (“ROM”), programmable ROM (“PROM”), erasable programmable ROM (“EPROM”), electrically erasable programmable ROM “EEPROM”), flash memory, etc.) coupled with the address/data bus 102, wherein the non-volatile memory unit 108 is configured to store static information and instructions for the processor 104. Alternatively, the computer system 100 may execute instructions retrieved from an online data storage unit such as in “Cloud” computing. In an aspect, the computer system 100 also may include one or more interfaces, such as an interface 110, coupled with the address/data bus 102. The one or more interfaces are configured to enable the computer system 100 to interface with other electronic devices and computer systems. The communication interfaces implemented by the one or more interfaces may include wireline (e.g., serial cables, modems, network adaptors, etc.) and/or wireless (e.g., wireless modems, wireless network adaptors, etc.) communication technology.

In one aspect, the computer system 100 may include an input device 112 coupled with the address/data bus 102, wherein the input device 112 is configured to communicate information and command selections to the processor 104. In accordance with one aspect, the input device 112 is an alphanumeric input device, such as a keyboard, that may include alphanumeric and/or function keys. Alternatively, the input device 112 may be an input device other than an alphanumeric input device. In an aspect, the computer system 100 may include a cursor control device 114 coupled with the address/data bus 102, wherein the cursor control device 114 is configured to communicate user input information and/or command selections to the processor 104. In an aspect, the cursor control device 114 is implemented using a device such as a mouse, a track-ball, a track-pad, an optical tracking device, or a touch screen. The foregoing notwithstanding, in an aspect, the cursor control device 114 is directed and/or activated via input from the input device 112, such as in response to the use of special keys and key sequence commands associated with the input device 112. In an alternative aspect, the cursor control device 114 is configured to be directed or guided by voice commands.

In an aspect, the computer system 100 further may include one or more optional computer usable data storage devices, such as a storage device 116, coupled with the address/data bus 102. The storage device 116 is configured to store information and/or computer executable instructions. In one aspect, the storage device 116 is a storage device such as a magnetic or optical disk drive (e.g., hard disk drive (“HDD”), floppy diskette, compact disk read only memory (“CD-ROM”), digital versatile disk (“DVD”)). Pursuant to one aspect, a display device 118 is coupled with the address/data bus 102, wherein the display device 118 is configured to display video and/or graphics. In an aspect, the display device 118 may include a cathode ray tube (“CRT”), liquid crystal display (“LCD”), field emission display (“FED”), plasma display, or any other display device suitable for displaying video and/or graphic images and alphanumeric characters recognizable to a user.

The computer system 100 presented herein is an example computing environment in accordance with an aspect. However, the non-limiting example of the computer system 100 is not strictly limited to being a computer system. For example, an aspect provides that the computer system 100 represents a type of data processing analysis that may be used in accordance with various aspects described herein. Moreover, other computing systems may also be implemented. Indeed, the spirit and scope of the present technology is not limited to any single data processing environment. Thus, in an aspect, one or more operations of various aspects of the present technology are controlled or implemented using computer-executable instructions, such as program modules, being executed by a computer. In one implementation, such program modules include routines, programs, objects, components and/or data structures that are configured to perform particular tasks or implement particular abstract data types. In addition, an aspect provides that one or more aspects of the present technology are implemented by utilizing one or more distributed computing environments, such as where tasks are performed by remote processing devices that are linked through a communications network, or such as where various program modules are located in both local and remote computer-storage media including memory-storage devices.

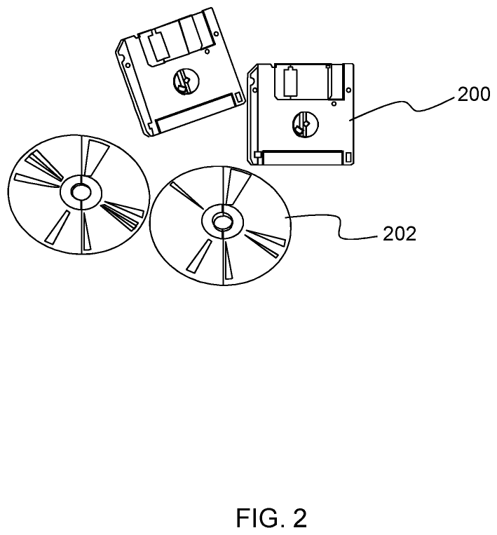

An illustrative diagram of a computer program product (i.e., storage device) embodying the present invention is depicted in FIG. 2. The computer program product is depicted as floppy disk 200 or an optical disk 202 such as a CD or DVD. However, as mentioned previously, the computer program product generally represents computer-readable instructions stored on any compatible non-transitory computer-readable medium. The term “instructions” as used with respect to this invention generally indicates a set of operations to be performed on a computer, and may represent pieces of a whole program or individual, separable, software modules. Non-limiting examples of “instruction” include computer program code (source or object code) and “hard-coded” electronics (i.e. computer operations coded into a computer chip). The “instruction” is stored on any non-transitory computer-readable medium, such as in the memory of a computer or on a floppy disk, a CD-ROM, and a flash drive. In either event, the instructions are encoded on a non-transitory computer-readable medium.

(2) Detailed Description

The following discussion provides example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

As used in the description in this application and throughout the claims that follow, the meaning of “a,” “an,” and “the” includes plural reference unless the context clearly dictates otherwise. Also, as used in the description in this application, the meaning of “in” includes “in” and “on” unless the context clearly dictates otherwise.

Also, as used in this application, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed considering the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements. Moreover, and unless the context dictates the contrary, all ranges set forth in this application should be interpreted as being inclusive of their endpoints and open-ended ranges should be interpreted to include only commercially practical values. Similarly, all lists of values should be considered as inclusive of intermediate values unless the context indicates the contrary.

It should be noted that any language directed to a computer should be read to include any suitable combination of computing devices, including servers, interfaces, systems, databases, agents, peers, Engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. A server can refer to one or more servers, including cloud servers that are configured to function together to act as a single server, etc. Data exchanges preferably are conducted over a packet-switched network, the Internet, LAN, WAN, VPN, or other type of packet switched network. The following description includes information that may be useful in understanding the present invention. It is not an admission that any of the information provided in this application is prior art or relevant to the presently claimed invention, or that any publication specifically or implicitly referenced is prior art.

(2.1) Specific Details of Various Embodiments

Platforms of the inventive subject matter (singularly referred to as a “transactions platform”) incorporate instant messaging to facilitate online-based, peer-to-peer transactions. Users can use various messaging programs (e.g., instant messengers, text messages, chat programs, such as Discord, Telegram, Skype, Facebook™ Messenger, WeChat, Viber, Apple iMessage, GroupMe, Kik, Microsoft Teams, Slack™, WebChat, LINE, KakaoTalk, and any mobile or desktop application which uses Microsoft Bot Framework Direct Line channel) to securely and reliably conduct a variety of peer-to-peer transactions. Transactions platforms can create contracts and use escrow accounts to mitigate risk (e.g., risk of losing money or points) and also help to mediate conflicts. Furthermore, transactions platforms can incorporate a chatbot service, referees, tracker software, and escrow agent software to facilitate all types of peer-to-peer transactions performed via messaging/chat programs.

As known to one skilled in the art, a chatbot is a software application used to conduct an online chat conversation between two or more users via text or text-to-speech, in lieu of providing direct contact with a live human agent. A referee is a user responsible for adjudicating disputes between two or more users that can't agree on the result of a match/bet in self-verify games, or when tracker software cannot determine the result of the match/bet and cannot perform an automatic settlement of the contract. A referee is selected automatically by the invention described herein, according to the rules of the transaction, from a pool of referees without a bias toward any party of the match/bet transaction and with expertise in the game that is being played and bet on. For example, if a bet to play NBA2K (a basketball video game developed by Virtual Concepts and Saber Interactive) accepted by two users and the contract is created, but the two players dispute the result of the game, then the system selects a referee with expertise in NBA2K to determine the result of the match.

For the purposes of this disclosure, tracker software is a software service on servers to automatically track the result of the match/bet/contract between two or more users (e.g., from buy/sell offers or from bets). Existing tracker software is used, for example, in video games and for tracking delivery of packages. The tracker software according to embodiments of the present disclosure communicates with third party tracking software or with game servers. Tracker software can use the escrow agent software to settle the contract (e.g., make payments) when the tracker software determines that the match/bet/contract is completed and can be settled. For video games, the tracker software tracks the gameplay results via am application programming interface (API) to game servers, interfaces to other tracker software for specific video games, or via API to overlay software on a user's computing device, or via monitoring of a user's broadcast/stream of the match. As understood by one skilled in the art, an API is a computing interface which defines interactions between multiple software intermediaries. For sports matches, the tracker software tracks the results of matches/sporting events via an interface to sports events reporting systems/services. For sold goods, the tracker software tracks the delivery of goods or a confirmation from a recipient that the goods have been received. For a services contract, the tracker software receives an acceptance message from the proper party of the contract.

Escrow Agent Software is a software and database to maintain user accounts, the escrow account, and a general ledger. When users enter into a contract after an offer/bet is accepted, then the escrow agent software transfers funds from the users' accounts to the escrow account to prevent cheating and/or refusal to pay after the contract is performed successfully. Once a contract is completed, as decided by the tracker software, mutually agreed to by users, or decided by a referee in case of a disputes, then the escrow agent software performs the settlement and transfers funds to the proper users or refunds both users.

Transactions platforms of the inventive subject matter can support and facilitate a wide variety of transactions, non-limiting examples of which include peer-to-peer contest outcome wagering (e.g., individuals can bet on themselves or others to win or perform according to some pre-determined criteria in activities ranging from video games to sporting events); peer-to-peer wagering on eSports tournaments (e.g., based on match results); peer-to-peer sports wagering (e.g., based on match results); peer-to-peer purchasing and sales of goods; peer-to-peer purchasing and sales of services; peer-to-peer stock trading; peer-to-peer currency exchange (e.g., real or crypto currencies); and pooling of resources to conduct group purchases. Thus, the inventive subject matter is directed to systems and methods of facilitating peer-to-peer transactions (e.g., on sports, e-sports, horse racing). Contemplated embodiments include transaction flows with and without a tracker (i.e., tracker software), as well as embodiments that include a referee to facilitate contract settlement. Once transactions are agreed upon (e.g., an offer is accepted, or a bet is won or lost), settlements are executed. Non-limiting examples of each embodiment are described in more detail below. Although steps are given in an order, it is contemplated that steps can be undertaken in alternative orders in many circumstances.

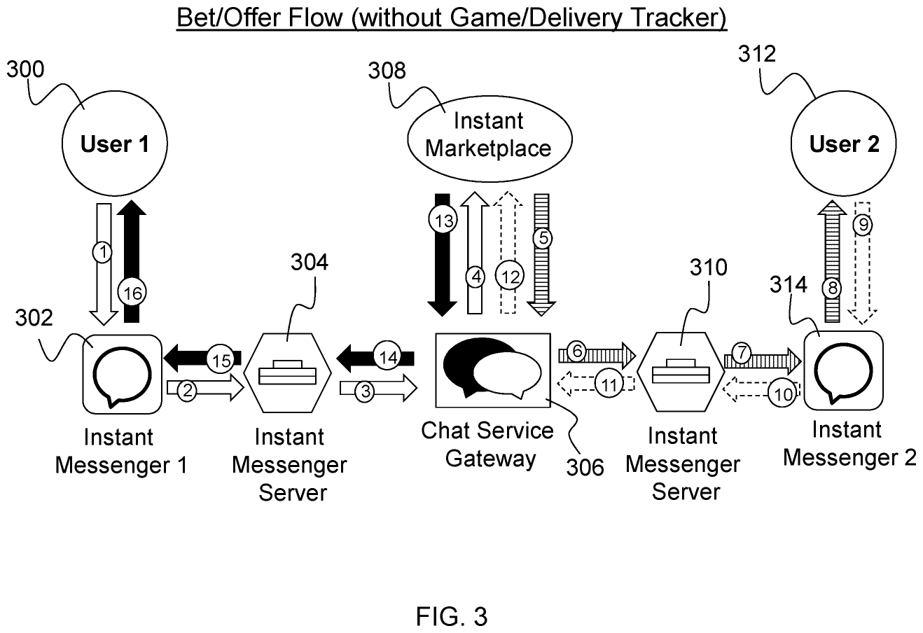

FIG. 3 shows a transaction flow that does not include a tracker. To begin, a first user initiates a transaction request, where a transaction request can include, for example, a bet/wager or a request to enter into a contract (e.g., to purchase goods or services). The request originates from a first user at that user's computing device. Non-limiting examples of computing devices include smartphones, tablets, and personal computers. Throughout this application, whenever a communication, request, or any type of electronic communication is described as coming from a user, this includes the user's computing device as needed to accomplish such a task. As shown in FIG. 3, a transaction request by a first user 300 is placed via instant messenger 1 302 in step 1. In step 2, instant messenger 1 302 transmits the transaction request to an instant messenger server 304, and the instant messenger server 304 then relays the request to a chat service gateway 306 according to step 3. A chat service gateway 306 of the inventive subject matter can include a server, or set of servers, configured to communicate with a plurality of different chat and instant messaging protocols (e.g., SMS (short message service), MMS (multimedia messaging service), e-mail, Discord, Telegram, Skype, Viber, LINE, WeChat, KakaoTalk, iMessage, Microsoft Teams, Facebook™ Messenger, WhatsApp™, Slack™).

In step 4, the request is sent to an instant marketplace server 308, which is a server where users can sell, buy, and trade different items. The marketplace server 308 uses information in the request to create a draft contract, credit an escrow account, and debit the first user 300. Next, as shown in steps 5-8, the instant marketplace server 308 sends the draft contract back through the chat service gateway 306 (step 5) before it is relayed to a second instant messenger server 310 (step 6). In some embodiments, the second instant messenger server 310 can be the same as the first instant messenger server 304 (e.g., if the first user and second user are both using the same instant messaging platform). The second instant messenger server 310 relays the draft contract to the second user 312 via instant messenger 2 (step 7) so that the second user 312 ultimately receives the draft contract (step 8).

Once the second user 312 has received the draft contract, the second user 312 has the option to accept, reject, or propose a modification to it. If the second user 312 accepts the contract, then, according to steps 9-12, an acceptance is transmitted from the second user 312 via instant messenger 2 314 (step 9) though the second instant messenger server 310 (step 10). The second instant messenger server 310 then relays the acceptance to the chat service gateway 306 (step 11), which passes the acceptance along to the marketplace server 308 (step 12). The marketplace server 308 then activates the contract, credits the escrow account, and debits the second user 312. A notification that the second user 312 accepted the draft contract is then transmitted to the first user 300 according to steps 13-16. The acceptance notification passes from the marketplace server 308 to the chat service gateway 306 (step 13) where it is relayed to the first instant messenger server 304 (step 14). The first instant messenger server 304 then sends the acceptance notification via instant messenger 1 302 to the first user 300 (steps 15 and 16), thus completing an offer and acceptance flow for any type of transaction that is carried out using a transactions platform of the inventive subject matter.

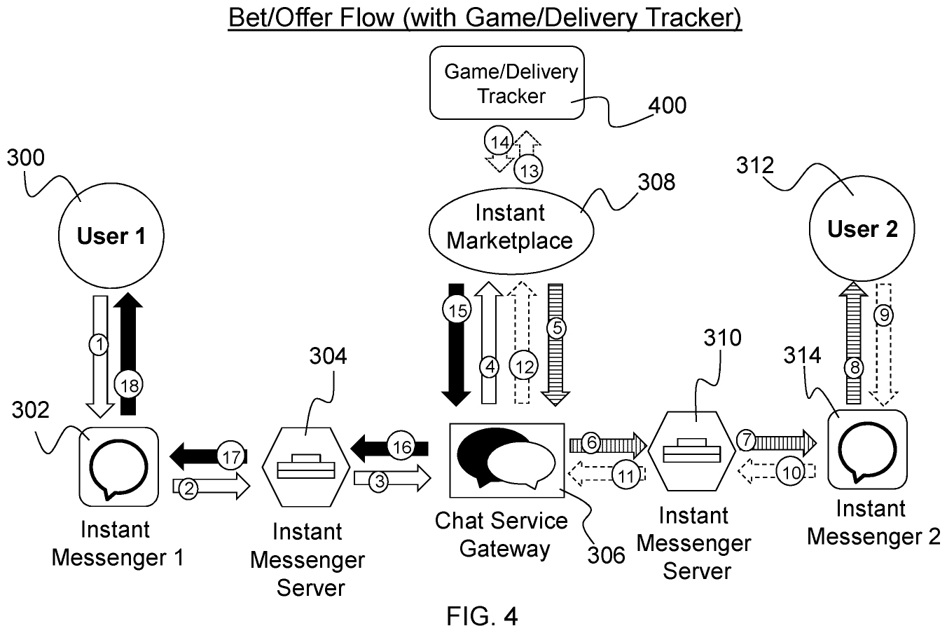

In some embodiments, such as the one shown in FIG. 4, a tracker can be incorporated. As in the embodiment shown in FIG. 3, the process in FIG. 4 begins with a first user 300 initiating a transaction request, where a transaction request can include, for example, a bet/wager or a request to enter into a contract (e.g., to purchase goods or services). The request originates from a first user 300 at that user's computing device, and the request is transmitted via instant messenger 1 302 as shown in FIG. 4 step 1. In step 2, instant messenger 1 302 transmits the transaction request to an instant messenger server 304 that then relays the request to a chat service gateway 306 according to step 3.

In step 4, the request is sent to a marketplace server 308 of the inventive subject matter. The marketplace server 308 creates a draft contract using information from the request, credits an escrow account, and debits the first user 300. Next, as shown in steps 5-8, the draft contract passes back through the chat service gateway 306 (step 5) before it is relayed to a second instant messenger server 310 (step 6). In some embodiments, the second instant messenger server 310 can be the same as the first instant messenger server 304. The second instant messenger server 310 relays the draft contract via instant messenger 2 314 (step 7) so that a second user 312 ultimately receives the draft contract (step 8).

Once the second user 312 has received the draft contract, the second user 312 has the option to accept, reject, or propose modifications to it. If the user accepts the contract, then, according to steps 9-12, an acceptance is transmitted from the second user 312 via instant messenger 2 314 (step 9) though the second instant messenger server 310 (step 10). The second instant messenger server 310 then relays the acceptance to the chat service gateway 306 (step 11), which passes the acceptance along to the marketplace server 308 (step 12). The marketplace server 308 then activates the contract, credits the escrow account, and debits the second user 312. Once the marketplace server 308 has activated the contract, a tracking request is sent to the tracker 400 (step 13), and the tracker 400 generates and responds with a tracking confirmation (step 14). With tracking activated, a notification that the second user 312 accepted the draft contract is then transmitted to the first user 300 according to steps 15-18. The acceptance notification passes from the marketplace server 308 to the chat service gateway 306 (step 15) where it is relayed to the first instant messenger server 304 (step 16). The first instant messenger server 304 then sends the acceptance notification via instant messenger 1 302 to the first user 300 (steps 17 and 18), thus completing a tracked offer and acceptance flow for any type of transaction that is carried out using a transactions platform of the inventive subject matter.

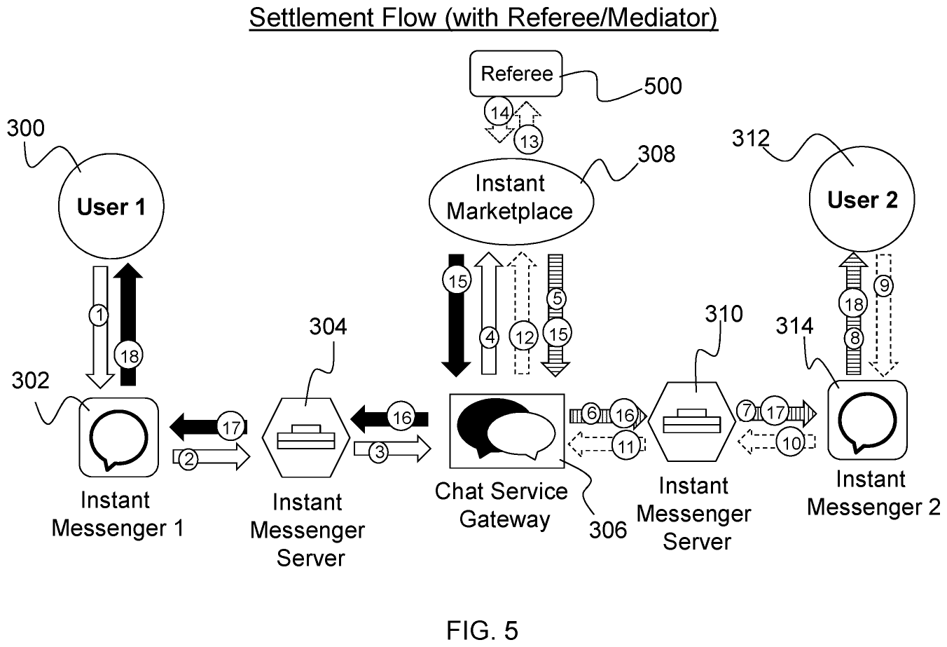

Once a contract is accepted, FIG. 5 depicts a non-limiting example of how a contract can be settled using a referee 500. Mediation can be needed when a first user 300 initiates a settlement request, but a second user 312 disagrees with the request or refuses settlement. First, the first user 300 (e.g., the user that initiated a transaction flow as described above regarding either FIG. 3 or FIG. 4) sends a settlement request to the marketplace server 308. The settlement request is sent via instant messenger 1 302 (step 1) to the first instant messenger server 304 (step 2). The first instant messenger server 304 relays the settlement request to the chat service gateway 306 (step 3), and the chat service gateway 306 sends the settlement request to the marketplace server 308 (step 4). The marketplace server 308, upon receiving the settlement request, changes the contract to a settling state and then transmits the settlement request (which can, in some embodiments, include information indicating the contract has been changed to a settling state) to the chat service gateway 306 (step 5). The chat service gateway 306 relays the settlement request to a second instant messenger server 310 (step 6). The second instant messenger server 310 then passes the settlement request to instant messenger 2 (step 7), and instant messenger 2 314 then sends the settlement request to the second user 312 (step 8). After the second user receives and refuses the settlement request, the second user sends a settlement refusal via instant messenger 2 314 (step 9) to the second instant messenger server 310 (step 10). The second instant messenger server 310 sends the settlement refusal to the chat service gateway 306 (step 11), and the chat service gateway 306 relays the settlement refusal to the marketplace server 308 (step 12). The marketplace server 308 receives the settlement refusal and changes the contract from a settling state to a mediated state and a referee 500 (or mediator) is selected to assist with settlement.

The marketplace server 308 then sends a notification to the selected referee 500 alerting them of their selection, and further sends the selected referee 500 the contract so that the referee 500 can make a settlement decision (step 13). Once the referee makes a settlement decision, the referee changes the contract to a settled state, debits the associated escrow account, credits each user account as needed, and credits a marketplace operational account and a credit referral account with a service fee. The referee 500 then sends a settlement confirmation to the marketplace server 308 (step 14), and the marketplace server 308 sends the settlement confirmation to the chat service gateway 306 (step 15). The chat service gateway 306 sends the settlement confirmation to the first instant messenger server 304 (step 16), which, in turn, relays the settlement confirmation to the first user via instant messenger 1 302 (steps 17 and 18).

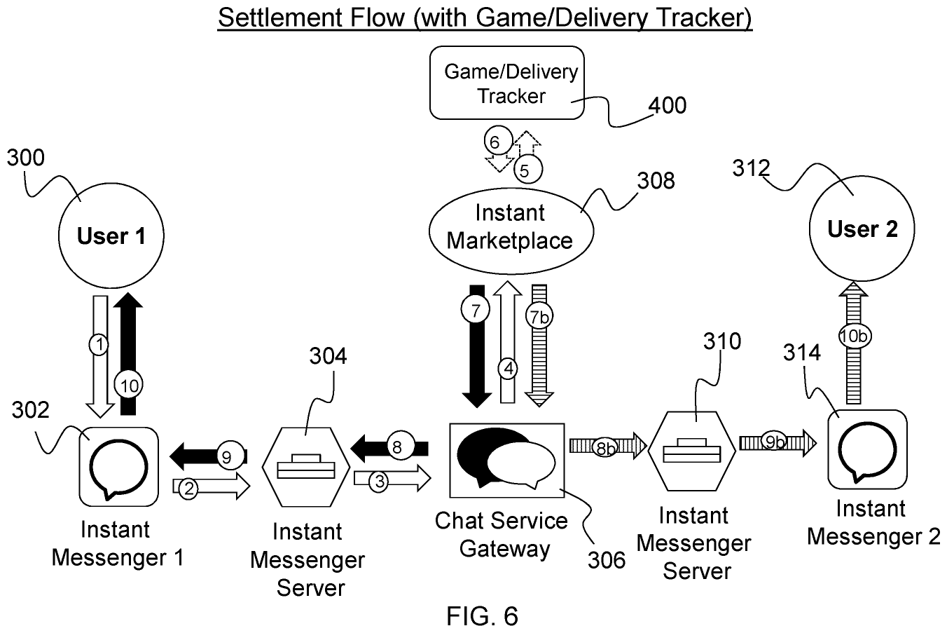

In other embodiments, settlements can be carried out without use of a referee 500. This process typically occurs when settlement is uncontested. FIG. 6 illustrates how a settlement flow with a tracker 400 can work. The first user 300 initiates a settlement request for a contract and sends that settlement request via instant messenger 1 302 to the first instant messenger server 304 (steps 1 and 2). The first instant messenger server 304 sends the settlement request to the chat service gateway 306 (step 3), and the chat service gateway 306 then sends the settlement request to the marketplace server 304 (step 4). The marketplace server 304 changes the contract to a settling state and sends a tracking request to the tracker 400 (step 5), where the tracking request asks the tracker 400 to verify or correct a settlement related to the contract. The tracker 400 changes the contract to a settled state, debits the escrow account, credits a specified user account, and credits a marketplace operational account and a credit referral account with a service fee based on the settled contract. Next, the tracker 400 sends a settlement notification to the marketplace server 304 indicating the settlement is complete (step 6). The marketplace server 304 receives the settlement notification and, subsequently, sends the settlement notification to, for instance, the first user 300 by sending the settlement notification to the chat service gateway 306 (step 7), which sends the settlement notification to the first instant messenger server 304 (step 8), which then sends the settlement notification to the first user 300 via instant messenger 1 302 (steps 9 and 10).

At around the same time (e.g., contemporaneously or in sequence with steps 7-10 described above), the marketplace server 308 can also send a second settlement notification to a second user 312 by sending the second settlement notification to the chat service gateway 306 (step 7b), which sends the second settlement notification to the second instant messenger server 310 (step 8b), and the second instant messenger server 310 then sends the second settlement notification to the second user 312 via instant messenger 2 314 (steps 9b and 10b), thereby ensuring both parties to a contract are notified of settlement.

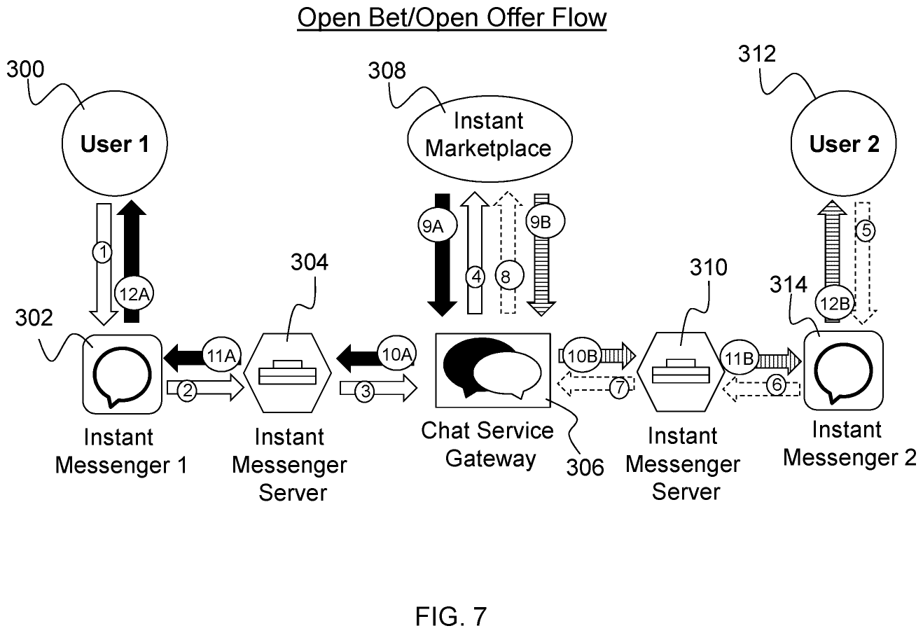

FIG. 7 shows an example of how an offer or bet can be open. To begin, a first user 300 initiates an open bet/open sell offer/open buy offer request without specifying another user (step 1). That request is transmitted from the first user 300 via instant messenger 1 302 to the first instant messenger server 304 (step 2), and the first instant messenger server 304 transmits the request to a chat service gateway 306 (step 3). The chat service gateway 306 then passes the request to the marketplace server 308 (step 4). The marketplace server 308 uses contents of the first user's 300 request to create a draft contract, credit an escrow account, and debit the first user's account. Next, a second user 312 creates an open bet/open buy offer/open sell offer request without specifying another user. The second user's 312 request is transmitted via instant messenger 2 314 to the second instant messenger server 310 (steps 5 and 6). The second instant messenger server 310 transmits the second user's 312 request to the chat service gateway 306 (step 7), and the chat service gateway 306 then passes the second user's 312 request to the marketplace server 308 (step 8). The marketplace server 308 receives the second user's 312 request and checks if it is a match for the first user's 300 request. If the marketplace server 308 identifies the second user's 312 request as a match (or correspondence) for the first user's 300 request (e.g., the second user 312 has placed an order to purchase items that the first user 300 is selling, and all other parameters such as price are agreed upon), then the marketplace server 308 then activates a contract between the first user 300 and the second user 312, credits an escrow account, and debits the second user's 312 account.

For identifying whether one user's request is a match for another user's in a betting scenario, the system described herein selects all pending open bets which have the same video game/game and amounts, adjusted by odds, that differ by no more than a predetermined percentage (e.g., 20%) to give users room for negotiations. An alternative matching method for betting is that the invention described herein selects all pending open bets which have the same video game/game, and the same score type rules to calculate a winner, and amounts, adjusted by odds, that differ by no more than a predetermined percentage (e.g., 20%) to give users room for negotiations. For products/services offered, the system described herein selects all offers to sell and offers to buy which have same product/service type selected from a catalog and amounts differing by no more than a predetermined percentage to give users room for negotiations.

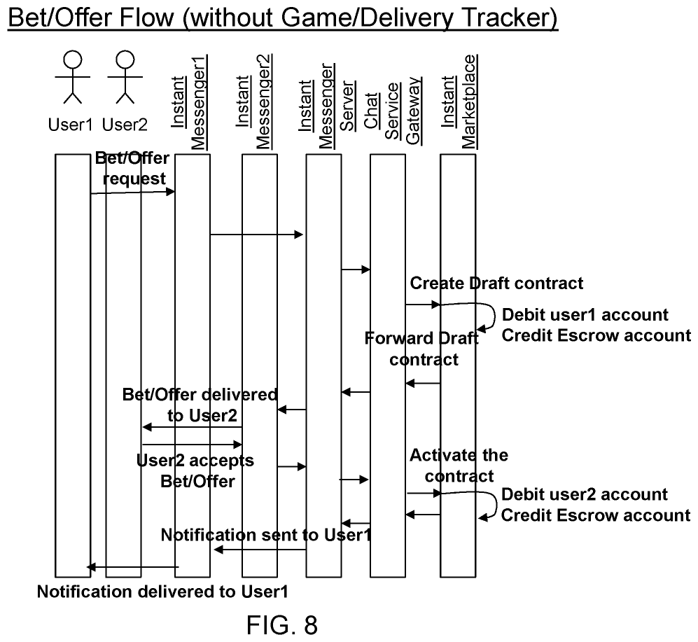

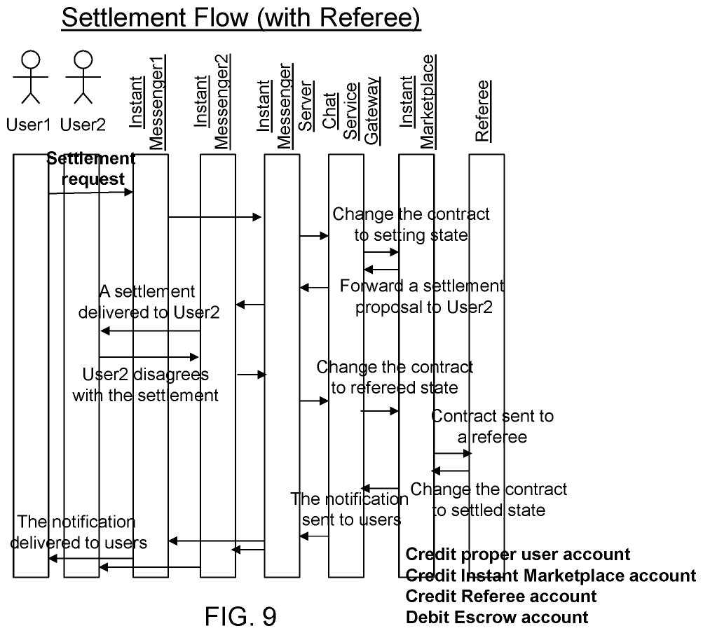

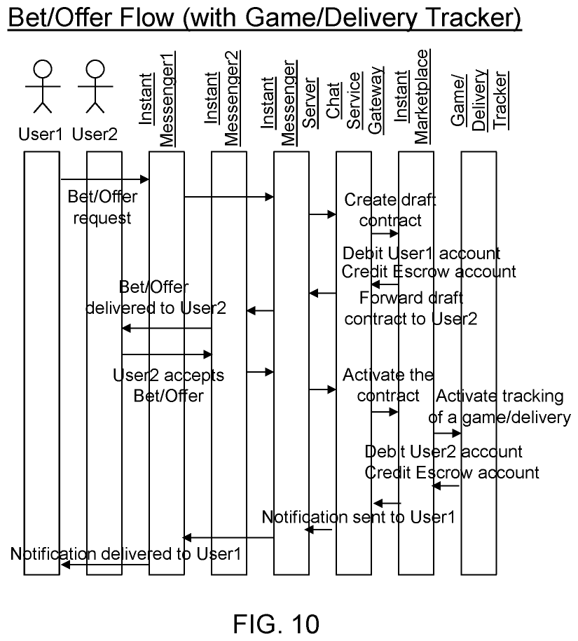

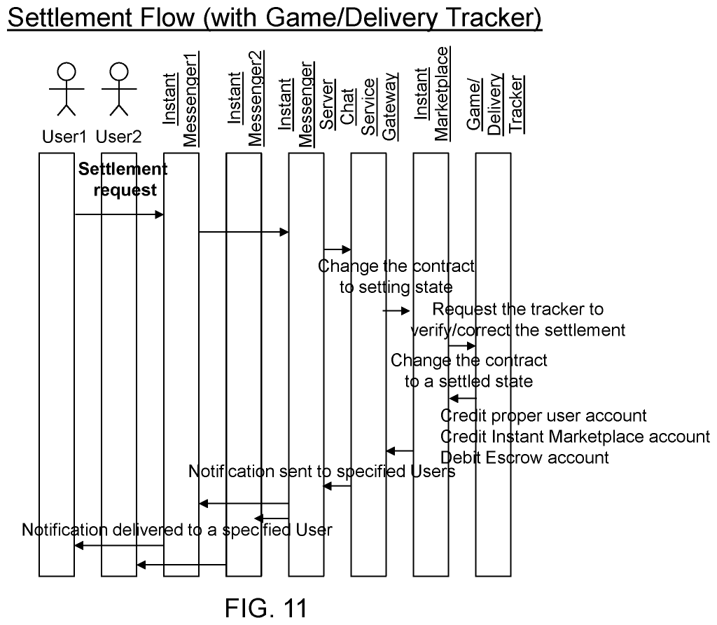

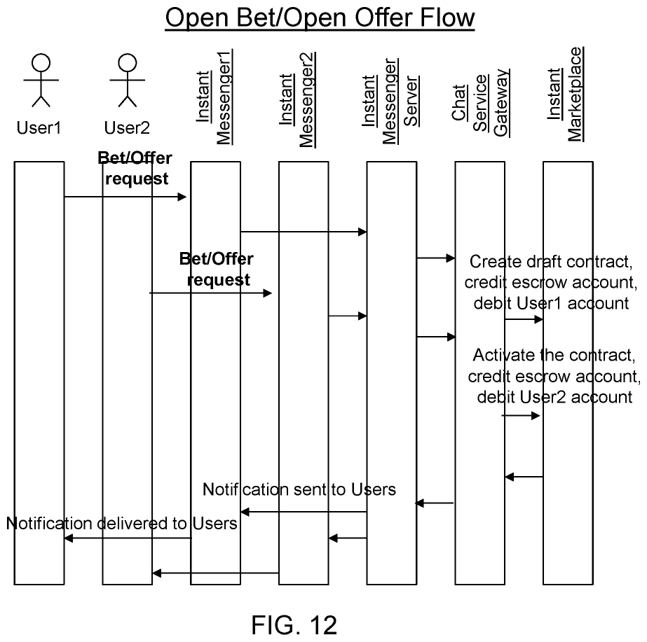

FIGS. 8-12 depict sequence diagrams showing the transactions illustrated in FIGS. 3-7. Specifically, FIG. 8 illustrates a transaction flow without a tracker; FIG. 9 illustrates a settlement flow that includes a referee; FIG. 10 illustrates a transaction flow with a tracker; FIG. 11 illustrates a settlement flow that includes a tracker; and FIG. 12 illustrates a transaction flow for a request from a first user and a matching request from a second user according to embodiments of the present disclosure.

In some embodiments, the marketplace server 308 distributes a notification to both the first user 300 and the second user 312. Notifications (e.g., a notification for the first user 300 and for the second user 312) are sent from the marketplace server 308 to the chat service gateway 306 (step 9A for the first user 300 and 9B for the second user 312). The chat service gateway 306 sends a notification for the first user 300 to the first instant messenger server 304, which then transmits the notification to the first user 300 via instant messenger 1 302 (steps 10A, 11A, and 12A). The chat service gateway 306 also sends a notification for the second user to the second instant messenger server, which then transmits the notification to the second user via instant messenger 1 (steps 10B, 11B, and 12B). These notifications can alert each user that a transaction has successfully been agreed upon and a transaction fulfilled.

Systems and methods of the inventive subject matter are widely applicable. In some embodiments, transactions platforms of the inventive subject matter can include a chatbot that facilitates different implementations including linking a transactions platform to video games, e-sports, or to tournaments and events. Chatbots integrated into a transactions platform can also make it easier for users to interface with the platform, to refer new users, and to find a user's friends, identify a user's games, and to identify a user's tournaments and events. It is contemplated that all interactions with a transactions platform of the inventive subject matter can be facilitated with and guided by a chatbot.

As described above, transactions platforms of the inventive subject matter can be used to facilitate betting. There is virtually no limit to what users can place bets on, so long as there is an offer, acceptance, and consideration associated with each contract that makes its way through a system. Thus, a contract as described above can include a proposed bet from a first user, which a second user must then choose whether to accept to reject. In some embodiments, bets from a first user are listed by the marketplace server for other users to browse and decide whether to accept.

Embodiments of the transactions platform can also facilitate peer-to-peer sales of goods and services. For example, if the first user wants to sell a washing machine, then the draft contract the first user prepare will include details of the item for sale including a proposed price, giving one or more other users an opportunity to accept or reject the contract. In some embodiments, the second user can propose a counteroffer, which the first user can then accept or reject (or propose an additional counteroffer). Counteroffers are treated the same as offers and initiating a counteroffer can simply restart a process described above from step 1 (e.g., a process as shown in FIGS. 3 and 4).

In some embodiments, communications can be initiated on an instant messenger program by a first user despite a second user operating on a different instant messenger program. This functionality is facilitated by implementing a chat service gateway, which can route messages (e.g., requests, responses, notifications) to a wide variety of different instant messenger servers (thereby making many different instant messenger services compatible with transactions platforms of the inventive subject matter), as described above. For example, a first user could propose a contract using Facebook™ messenger, and the second user could be given an option to accept that contract via WeChat™. Users can set preferences with the transactions platform indicating a preferred instant messaging service (and, in some embodiments, indicating a second choice for instant messaging).

Additionally, any user 300 can send a direct bet/offer to a selected person via a Chat Bot gateway-marketplace server (i.e., the combination of the chat service gateway 306 and the marketplace server 308), as shown in FIGS. 3 and 4. In addition, any user 300 can send an open bet/offer to all pending opposite bets/offers, and the marketplace server 308 will auto-match them, as depicted in FIG. 7. Furthermore, any user 300 can send an open bet/offer to the Chat Bot gateway-marketplace server 306 and 308 to store it in the database and allow all users to search it, as illustrated in FIG. 7.

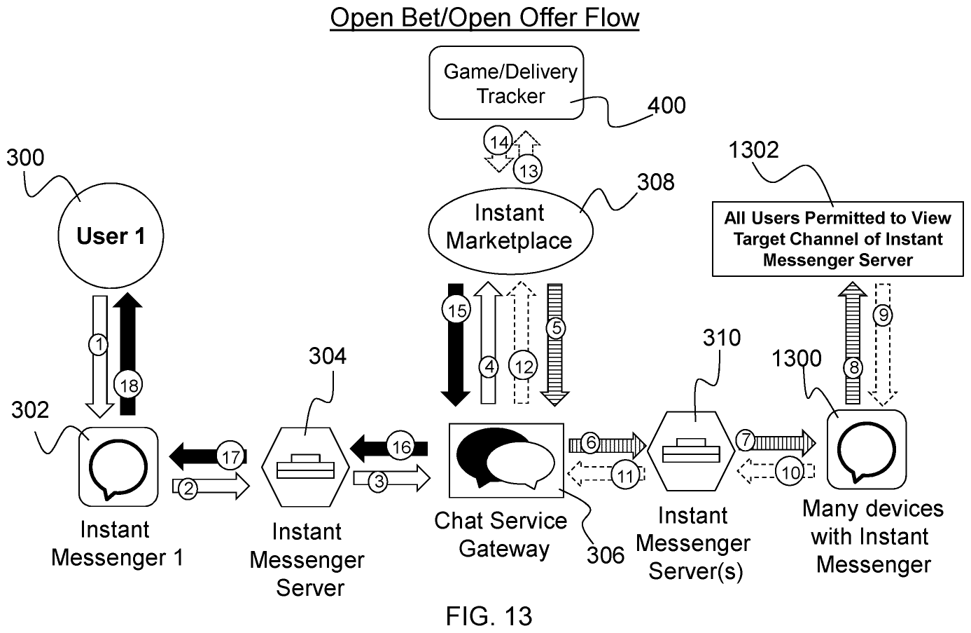

In another embodiment and as shown in FIG. 13, a user 300 can send an open offer/bet to the Chat Bot gateway-marketplace server 306 and 308 through to many devices with instant messenger 1300 and forward it to public/shared chat channel(s) for all users of these channel(s) to see in step 8 (i.e., All Users Permitted to View Target Channel of Instant Messenger Server 1302), with one user accepting or countering the offer/bet in step 9.

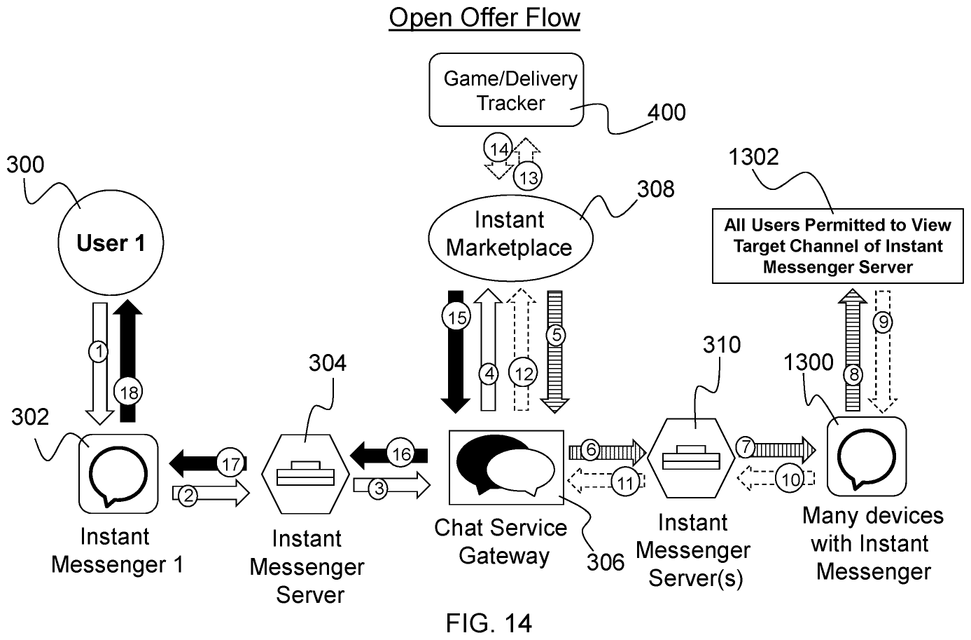

As depicted in FIG. 14, a user 300 can also send an open offer of goods/services to the Chat Bot gateway-marketplace server 306 and 308 through to many devices with instant messenger 1300 and forward it to public/shared chat channel(s) for all users of these channel(s) to see in step 8 (i.e., All Users Permitted to View Target Channel of Instant Messenger Server 1302), and many users independently to accept in step 9.

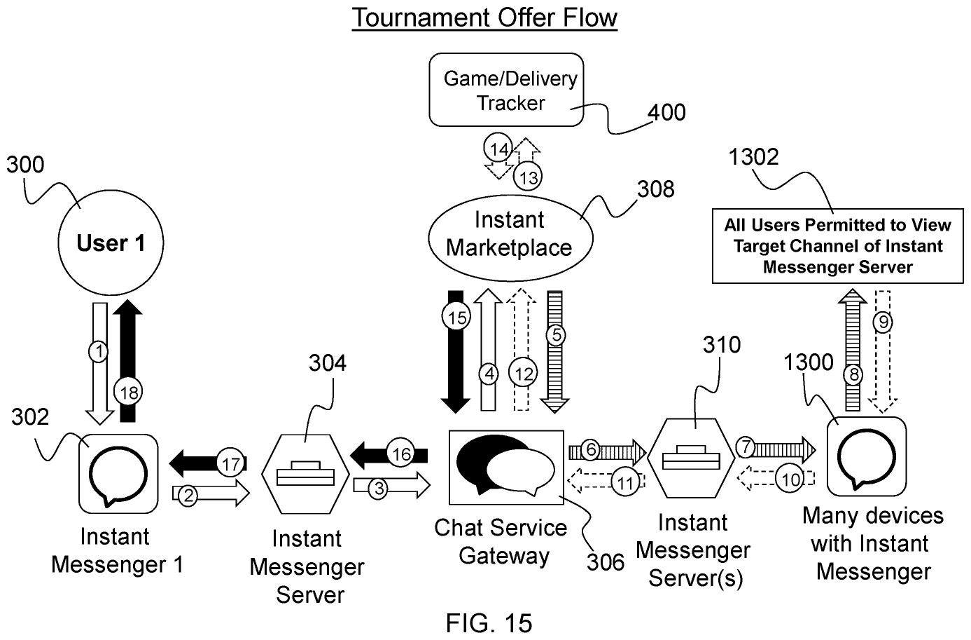

In another embodiment and as illustrated in FIG. 15, an authorized user 300 can send an open offer to join the tournament to the Chat Bot gateway-marketplace server 306 and 308 through to many devices with instant messenger 1300 and forward it to public/shared chat channel(s) for all users of that channel(s) to see in step 8, and many of the users to join independently in step 9. The offer can specify a limit on number of users who can join.

Finally, an authorized user 300 can send an open offer to join a tournament to the Chat Bot gateway-marketplace server 306 and 308 to forward it to individual users 302 to join, as shown in FIGS. 3 and 4. In each of these cases, users who receive a bet/offer through the Chat Bot gateway-marketplace server 306 and 308 can accept/join by pressing [Accept] or [Join] reaction/button in a bet/offer message. This action executes escrow agent software to transfer required funds to escrow and finalize the contract, as described in detail above.

Systems and methods directed to a transactions platform have been disclosed herein. It should be apparent, however, to those skilled in the art that many more modifications besides those already described are possible without departing from the inventive concepts in this application. The inventive subject matter, therefore, is not to be restricted except in the spirit of the disclosure. Moreover, in interpreting the disclosure, all terms should be interpreted in the broadest possible manner consistent with the context. In particular the terms “comprises” and “comprising” should be interpreted as referring to the elements, components, or steps in a non-exclusive manner, indicating that the referenced elements, components, or steps can be present, or utilized, or combined with other elements, components, or steps that are not expressly referenced.

Finally, while this invention has been described in terms of several embodiments, one of ordinary skill in the art will readily recognize that the invention may have other applications in other environments. It should be noted that many embodiments and implementations are possible. Further, the following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”. Further, while particular method steps have been recited in a particular order, the method steps may occur in any desired order and fall within the scope of the present invention.

What is claimed is:

1. A system for peer-to-peer transactions using instant messaging programs, the system comprising:
a first computing device configured with a first instant messenger program and in electronic communication with a first instant messenger server;
a second computing device configured with a second instant messenger program and in electronic communication with a second instant messenger server;
a chat service gateway comprising one or more servers configured to communicate with both the first instant messenger server and the second instant messenger server; and
a marketplace server configured to communicate with the chat service gateway,
wherein the combination of the first and second computing devices, the first and second instant messenger servers, the chat service gateway, and the marketplace server are configured to perform a transaction between the first and second computing devices via the first and second instant messenger programs.

2. The system as set forth in claim 1, further comprising a tracker software in communication with the marketplace server, wherein the tracker software is configured to automatically track a result of the transaction between the first and second computing devices.

3. The system as set forth in claim 1, further comprising a referee in communication with the marketplace server, wherein the referee is configured to assist with settlement of the transaction.

4. A method for peer-to-peer transactions using instant messaging programs, the method comprising acts of:
initiating a transaction request between a first computing device configured with a first instant messenger program and a second computing device configured with a second instant messenger program, wherein initiating the transaction request comprises:
transmitting the transaction request from the first computing device to a first instant messenger server via the first instant messenger program;
relaying, by the first instant messenger server, the transaction request to a chat service gateway, wherein the chat service gateway comprises one or more servers configured to communicate with a plurality of different instant messenger servers;
sending, by the chat service gateway, the transaction request to a marketplace server, wherein the marketplace server creates a contract, credits an escrow account, and debits the first computing device;
sending, by the marketplace server, the contract through the chat service gateway to a second instant messenger server; and
relaying, by the second instant messenger server, the contract to the second computing device via the second instant messenger program.

5. The method as set forth in claim 4, further comprising an act of accepting the contract by the second computing device, wherein accepting the contract comprises:
transmitting an acceptance of the contract from the second computing device through the second instant messenger server via the second instant messenger program;
relaying, by the second instant messenger server, the acceptance to the chat service gateway to the marketplace server, wherein the marketplace server activates the contract, credits the escrow account, and debits the second computing device;
transmitting an acceptance notification to the first computing device from the marketplace server to the chat service gateway;
relaying the acceptance notification from chat service gateway to the first instant messenger server;
sending, by the first instant messenger server, the acceptance notification to the first computing device via the first instant messenger program.

6. The method as set forth in claim 5, further comprising acts of:
sending a tracking request to a tracker software once the marketplace server activates the contract; and
generating, by the tracker software, a tracking confirmation,
wherein the tracker software tracks a result of the contract between the first computing device and the second computing device.

7. The method as set forth in claim 5, the method further comprises acts of:
sending, by the first computing device, a settlement request to the marketplace server, wherein the marketplace server changes the contract to a settling state;
transmitting, by the marketplace server, a settlement request to the chat service gateway, wherein the chat service gateway relays the settlement request to the second instant messenger server;
sending, by the second instant messenger server, to the second computing device via the second instant messenger program;
sending, by the second computing device, a settlement refusal to the second instant messenger server via the second instant messenger program when the second computing device refuses the settlement request;
sending, by the second instant messenger server, the settlement refusal to the chat service gateway, wherein the chat service gateway transmits the settlement refusal to the marketplace server;
changing, by the marketplace server, the contract from the settling state to a mediated state; and
selecting a referee to assist with settlement of the contract, wherein the marketplace server sends a notification to the selected referee, and wherein the selected referee makes a settlement decision.

8. The method as set forth in claim 7, wherein the referee changes the contract to a settled state, debits the escrow account, and credits one or more of the computing devices, and wherein the method further comprises acts of:
sending, by the referee, a settlement confirmation to the marketplace server, wherein the marketplace server sends the settlement confirmation to the chat service gateway; and
sending, by the chat service gateway, the settlement confirmation to the first instant messenger server which relays the settlement confirmation to the first computing device via the first instant messenger program.

9. A method for peer-to-peer transactions using instant messaging programs, the method comprising acts of:
transmitting a first transaction request from a first computing device to a first instant messenger server via a first instant messenger program;
relaying, by the first instant messenger server, the first transaction request to a chat service gateway, wherein the chat service gateway comprises one or more servers configured to communicate with a plurality of different instant messenger servers;
sending, by the chat service gateway, the first transaction request to a marketplace server, wherein the marketplace server creates a contract, credits an escrow account, and debits the first computing device;
transmitting a second transaction request from a second computing device to a second instant messenger server via a second instant messenger program;
relaying, by the second instant messenger server, the second transaction request to the chat service gateway;
checking, by the marketplace server, that the second transaction request corresponds to the first transaction request; and
activating, by the marketplace server, a contract between the first computing device and the second computing device, wherein the marketplace server creates a contract, credits an escrow account, and debits the second computing device.

10. A method for peer-to-peer transactions using instant messaging programs, the method comprising acts of:
initiating a transaction request between a first computing device configured with a first instant messenger program and a plurality of computing devices configured with a plurality of instant messenger programs, wherein initiating the transaction request comprises:
transmitting the transaction request from the first computing device to a first instant messenger server via the first instant messenger program;
relaying, by the first instant messenger server, the transaction request to a chat service gateway, wherein the chat service gateway comprises one or more servers configured to communicate with a plurality of different instant messenger servers;
sending, by the chat service gateway, the transaction request to a marketplace server, wherein the marketplace server creates a contract, credits an escrow account, and debits the first computing device;
sending, by the marketplace server, the contract through the chat service gateway to one or more instant messenger servers; and
relaying, by the one or more instant messenger servers, the contract to the plurality of computing devices via the plurality of instant messenger programs.
